(19) United States
(12) Patent Application Publication
(10) Pub. No.: US 2014/0107820 A1
(43) Pub. Date: Apr. 17, 2014

(54) Audio Equipment and Wireless Electronic Device Combination System

(71) Applicant: Shih-Yao CHEN, New Taipei City (TW)

(72) Inventor: Shih-Yao CHEN, New Taipei City (TW)

(21) Appl. No.: 13/652,927

(22) Filed: Oct. 16, 2012

(51) Int. Cl. G06F 17/00

(52) U.S. Cl. 700/94

(57) ABSTRACT

An audio equipment and wireless electronic device combination system includes an audio equipment having set therein an audio player system, a wireless electronic device, a data stream connected between the wireless electronic device and the audio player system of the audio equipment using Wi-Fi (Wireless Fidelity) or data packet transmission technology. The audio player system includes a CPU for processing the data stream.

### BACKGROUND OF THE INVENTION

1. Field of the Invention

The present invention relates to medical cosmetic technology and more particularly, to an audio equipment and wireless electronic device combination system, which comprises a home or car audio equipment having set therein an audio player system, a wireless electronic device, and a data stream connected between the wireless electronic device and the audio player system of the audio player using Wi-Fi (Wireless Fidelity) or data packet transmission technology.

2. Description of the Related Art

Mobile electronic devices have become requisites of many people either at home or outdoors. The functions and forms of these mobile electronic devices change rapidly. Related technology has been continuously developing.

Further, notebooks, tablet computers, smart phones and other mobile electronic devices commonly adopt wireless communication for connection to the internet for web browsing, data searching, data downloading or other purposes. Modern people almost all the time will carry such wireless mobile electronic device.

Further, modern audio equipments, including home audio equipments and car audio equipments have also been widely used. However, subject to space and system function limitations, the user must approach the audio equipment when going to control the operation of the audio equipment. For example, a car audio equipment has a variety of small control buttons arranged on the face panel thereof for the control of different functions. It is inconvenient to operate these small control buttons. A home audio equipment may provide a remote control, allowing the user to control its operation by means of a remote controller. However, the remote controller is normally placed nearby the audio equipment. The user cannot manipulate the audio equipment anywhere.

### SUMMARY OF THE INVENTION

The present invention has been accomplished under the circumstances in view. It is one object of the present invention to provide an audio equipment and wireless electronic device combination system, which establishes communication between an audio equipment and a wireless electronic device, such as smart phone, tablet PC or notebook, using a Wi-Fi (Wireless Fidelity) or data packet transmission data stream.

It is another object of the present invention to provide an audio equipment and wireless electronic device combination system, which uses a cost-effective built-in structure for Wi-Fi (Wireless Fidelity) or data packet transmission, facilitating operation.

It is still another object of the present invention to provide e an audio equipment and wireless electronic device combination system, allows one wireless electronic device to control the operation of multiple audio equipments synchronously.

To achieve these and other objects of the present invention, an audio equipment and wireless electronic device combination system comprises at least one audio equipment, each audio equipment comprising an audio player system, at least one wireless electronic device, a data stream connected between the at least one wireless electronic device and the audio player system of each audio equipment using Wi-Fi (Wireless Fidelity) or data packet transmission technology, and a central processing unit built in the audio player system of each audio equipment and adapted to process the data stream.

Further, the at least one wireless electronic device can be selected from the group of smart phone, tablet computer and notebook.

Further, the audio player system of each audio equipment further comprises a wireless communication module electrically connected to the central processing unit and adapted to establish a communication protocol interface with the at least one wireless electronic device for reading radio frequency signals, a power management device electrically connected to the central processing unit for power supply management, a DSP (data signal processor) electrically connected to the central processing unit for sound volume control and signal processing, and a wireless receiver and decoder device electrically connected to the central processing unit for receiving and decoding wireless signals.

Further, the wireless communication module is incorporated with an application software and an operating system to provide the function of an access point or router for establishing a wireless network environment.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 illustrates a system architecture of an audio equipment and wireless electronic device combination system in accordance with the present invention.

FIG. 2 is a circuit block diagram of the audio player system of the audio equipment of the audio equipment and wireless electronic device combination system in accordance with the present invention.

FIG. 3 is a block diagram illustrating the operation of the audio equipment and wireless electronic device combination system in accordance with the present invention.

### DETAILED DESCRIPTION OF THE PREFERRED EMBODIMENT

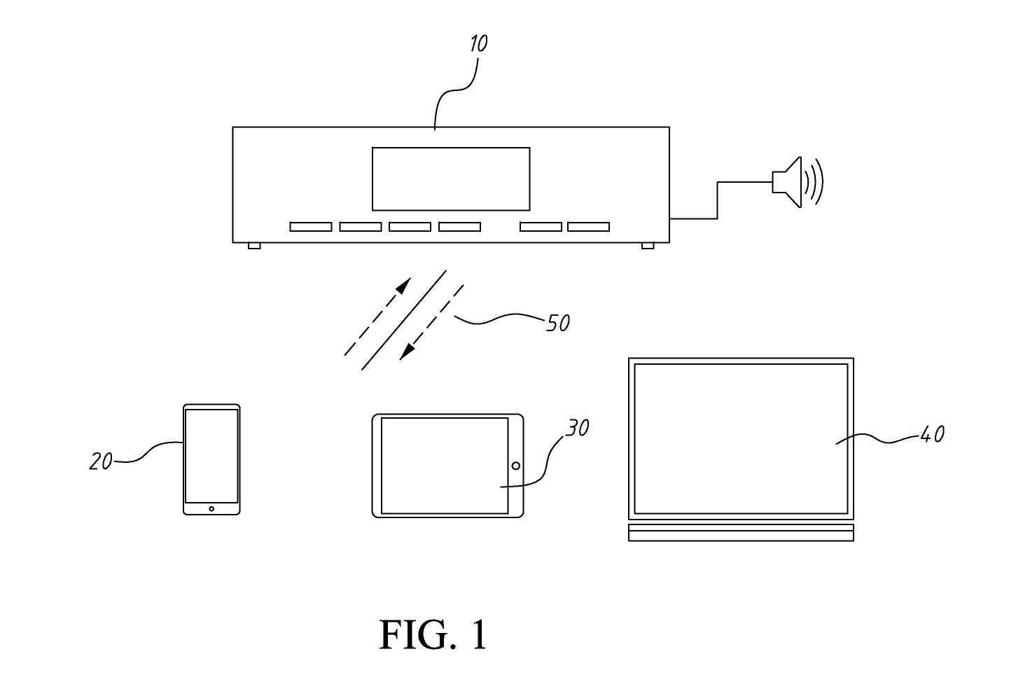

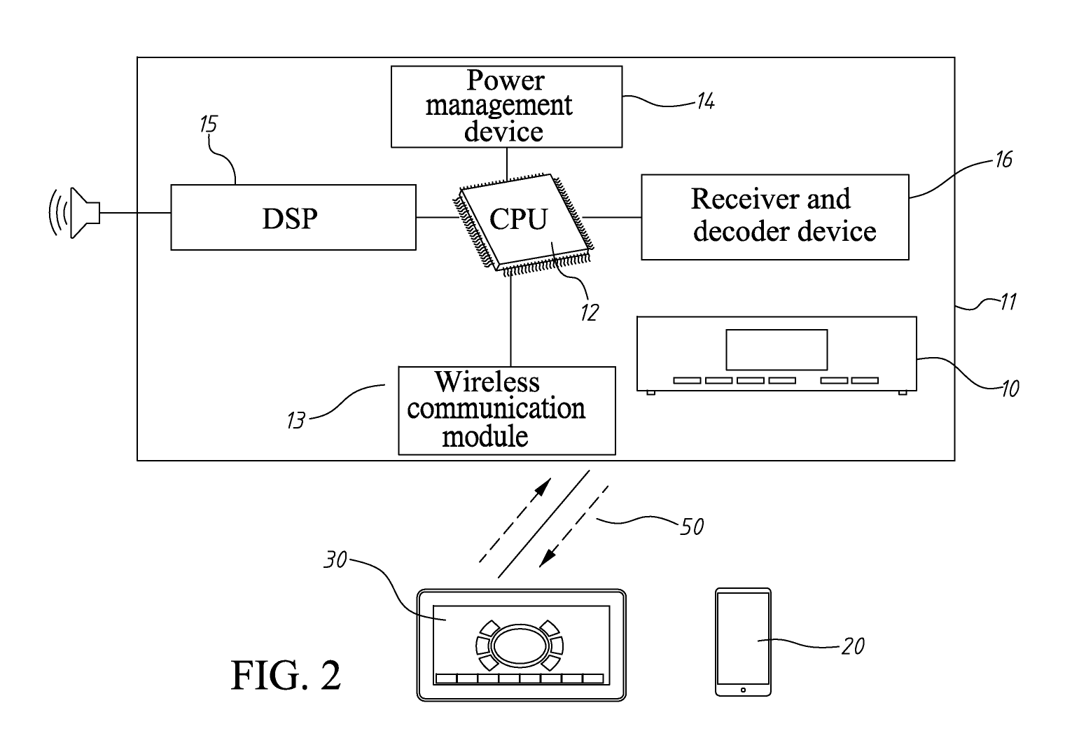

Referring to FIG. 1, an audio equipment and wireless electronic device combination system in accordance with the present invention is shown comprising an audio equipment 10, and a mobile electronic device that can be, but not limited to, smart phone 20, tablet computer 30 or notebook 40 for controlling the operation of the audio equipment 10 by a data stream 50 using Wi-Fi (Wireless Fidelity) or data packet transmission technology. The data stream 50 contains data, command, and audio. The audio equipment 10 can be a home audio equipment or car audio equipment, comprising an audio player system 11 (see FIG. 2).

Referring to FIG. 2, the audio player system 11 of the audio equipment 10 comprises a CPU 12, a wireless communication module, for example, Wi-Fi chips 13, a power management device 14, a DSP (data signal processor) 15, and a receiver and decoder device 16 that is configured subject to Wi-Fi protocol or any other wireless standard. The CPU 12 is a memory and math function integrated device capable of running an operating system (for example, Linus or Android) and related micro application software (for example, R1/M1 media player) and having built therein a ROM (read only memory) or RAM (random access memory). The wireless communication module (Wi-Fi chips) 13 is electrically coupled to the CPU 12, and adapted to establish a communication protocol interface with an IC of the master wireless electronic device (smart phone 20, tablet computer 30 or notebook 40) for reading radio frequency signals. Subject to the functioning of an application software and an operating system, the wireless communication module (Wi-Fi chips) 13 can provide the function of an access point or router to establish a wireless network environment.

The power management device 14, the DSP (data signal processor) 15 and the receiver and decoder device 16 are respectively electrically coupled to the CPU 12.

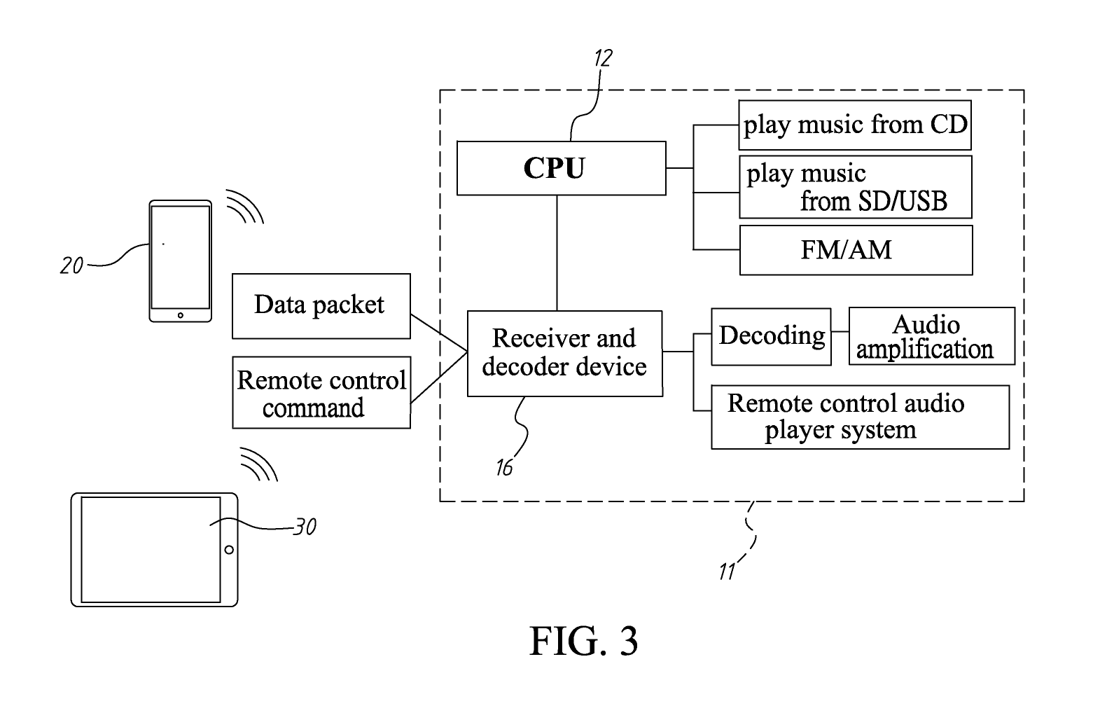

Referring to FIG. 3, during application, a user can operate a smart phone 20, tablet computer 30 or notebook 40 to transmit a data stream 50, which contains, for example, audio data, to the audio player system 11 of the audio equipment 10 subject to the Wi-Fi (Wireless Fidelity) protocol or a predetermined data packet transmission technology (see FIG. 1), enabling the data stream 50 to be outputted through the audio player system 11. The data stream 50 transmitted by the smart phone 20, tablet computer 30 or notebook 40 to the audio player system 11 is received by the wireless communication module (Wi-Fi chips) 13, and then decoded and amplified by the receiver and decoder device 16 subject to the control of the CPU 12, enabling the amplified audio to be outputted by the audio player system 11. Thus, data stream 50 transmitted by the master wireless electronic device, for example, smart phone 20, tablet computer 30 or notebook 40, to the audio player system 11 of the audio equipment 10 is received, decoded and amplified by the receiver and decoder device 16. Subject to the application of a control application software, the user can operate the smart phone 20, tablet computer 30 or notebook 40 to transmit a command to the audio player system 11, controlling the operation of the audio player system 11 of the audio equipment 10 to play music from CD or SD/USB, or to select FM/AM.

The invention allows wireless transmission between a wireless electronic device and an audio equipment, having the advantages of ease of operation and low cost. Subject to the advantage of built-in design, a consumer can use his or her personal mobile electronic device to control the operation of an audio equipment that is constructed according to the present invention.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. An audio equipment and wireless electronic device combination system, comprising at least one audio equipment, each said audio equipment comprising an audio player system, at least one wireless electronic device, a data stream connected between said at least one wireless electronic device and the audio player system of each said audio equipment using Wi-Fi (Wireless Fidelity) or data packet transmission technology, and a central processing unit built in the audio player system of each said audio equipment and adapted to process said data stream.

2. The audio equipment and wireless electronic device combination system as claimed in claim 1, wherein said at least one wireless electronic device is selected from the group of smart phone, tablet computer and notebook.

3. The audio equipment and wireless electronic device combination system as claimed in claim 1, wherein said at least one wireless electronic device comprises a personal computer.

4. The audio equipment and wireless electronic device combination system as claimed in claim 1, wherein the audio player system of each said audio equipment further comprises a wireless communication module electrically connected to said central processing unit and adapted to establish a communication protocol interface with said at least one wireless electronic device for reading radio frequency signals, a power management device electrically connected to said central processing unit for power supply management, a DSP (data signal processor) electrically connected to said central processing unit for sound volume control and signal processing, and a wireless receiver and decoder device electrically connected to said central processing unit for receiving and decoding wireless signals.

5. The audio equipment and wireless electronic device combination system as claimed in claim 2, wherein the audio player system of each said audio equipment further comprises a wireless communication module electrically connected to said central processing unit and adapted to establish a communication protocol interface with said at least one wireless electronic device for reading radio frequency signals, a power management device electrically connected to said central processing unit for power supply management, a DSP (data signal processor) electrically connected to said central processing unit for sound volume control and signal processing, and a wireless receiver and decoder device electrically connected to said central processing unit for receiving and decoding wireless signals.

6. The audio equipment and wireless electronic device combination system as claimed in claim 3, wherein the audio player system of each said audio equipment further comprises a wireless communication module electrically connected to said central processing unit and adapted to establish a communication protocol interface with said at least one wireless electronic device for reading radio frequency signals, a power management device electrically connected to said central processing unit for power supply management, a DSP (data signal processor) electrically connected to said central processing unit for sound volume control and signal processing, and a wireless receiver and decoder device electrically connected to said central processing unit for receiving and decoding wireless signals.

7. The audio equipment and wireless electronic device combination system as claimed in claim 4, wherein said wireless communication module is incorporated with an application software and an operating system to provide the function of an access point or router for establishing a wireless network environment.
